(19) United States
(12) Patent Application Publication
(10) Pub. No.: US 2024/0330827 A1
(43) Pub. Date: Oct. 3, 2024

(54) IRRIGATION CONTROL USING FORECAST CROP YIELD POTENTIAL

(71) Applicant: South Country Equipment Ltd, Emerald Park (CA)

(72) Inventors: Ryan Hutchison, Emerald Park (CA); Kendall Gee, Emerald Park (CA)

(21) Appl. No.: 18/738,710

(22) Filed: Jun. 10, 2024

Related U.S. Application Data
(63) Continuation-in-part of application No. 16/140,220, filed on Sep. 24, 2018.

(30) Foreign Application Priority Data
Dec. 6, 2017 (CA) 2,987,761

(51) Int. Cl. G06Q 10/0637; G06Q 10/04; G06Q 50/02

(52) U.S. Cl. CPC G06Q 10/06375; G06Q 10/04; G06Q 50/02

(57) ABSTRACT

A method for forecasting crop yield and controlling irrigation at a field site based on plant-available water within a growing season. The method involves establishing a desired crop yield, using historical precipitation data to calculate historical seasonal precipitation values, and determining initial moisture factors, historical yields, and permanent wilting points for the field site. Periodic moisture readings are captured at the rooting depth. These values, along with current and forecasted precipitation data, are used to calculate the total available moisture and crop water use efficiency factors. The yield potential (YP) is then calculated, and if it is deviant from the established desired crop yield, control signals are sent to irrigation controllers to adjust water application at the field site. This dynamic irrigation control optimizes water usage to align the calculated yield potential with the desired crop yield, ensuring efficient resource use and improved crop production outcomes.

### CROSS REFERENCE TO RELATED APPLICATION

This continuation-in-part application claims the benefit of priority of U.S. application Ser. No. 16/140,220 filed Sep. 24, 2018 for IRRIGATION CONTROL USING FORECAST CROP YIELD POTENTIAL, which is hereby incorporated by reference in its entirety.

### FIELD OF THE INVENTION

This invention relates to precision agricultural forecasting methods and tools for use with field crops. Specifically, it pertains to a method of forecasting crop yield potential within a growing season using plant-available water metrics and controlling irrigation at the field site based on these metrics. The invention integrates real-time data from historical and current precipitation sources and ground moisture re and utilizes a computer-implemented control system to optimize irrigation, thereby enhancing crop yield predictions and water usage efficiency.

### BACKGROUND

Agricultural production methods and agronomic practices become more sophisticated every year-many types of very sophisticated crop management practices have been developed based upon variable rate crop inputs, planting zones, crop types and the like and it is in this general field of the present invention is located. There is ongoing interest and need to optimize and maximize agricultural field crop production.

There are only a few variables which an agricultural producer can use or work in developing and executing the crop production strategy. Soil type and field characteristics are very important factors along with the crop type being planted. Water is arguably the most important yield-limiting factor for crop production in many geographic areas including the North American Prairie growing regions. Once a crop has been planted at a particular field location, in-season adjustments or variables are limited to fertilizer or nutrient application, herbicides or pesticides etc., or in some environments where equipment are available irrigation can also be used. Dependent upon the desired crop yield outcome, that is to say, the desired yield, quality or the like of the crop, particular combinations of irrigation, inputs, nutrients might make ultimate economic sense for a farmer.

The water available to crops and the timing of its availability are believed to be two key metrics which can accurately forecast on a real-time basis the likely yield potential for a selected crop to field site growing season, to allow for economic monitoring and potential intervention. While many agricultural and agronomic decision-support tools in the past have been relied upon rainfall at a particular location to forecast crop performance and production, it is believed that if a method of estimating yield potential could be created that factored in the concept of plant-available water-which has not been done to date—this would be a significant advance in the available tools and decision-making supports for farmers.

The concept of plant-available water has been considered by academics in the field as a significant variable in the determination of crop yield, and it is believed that if an effective agricultural decision support tool which relied upon plant-available water as a primary decision metric could be developed this would be a very desirable tool for use by many agricultural producers. If a particular field site dries out to its permanent wilting point, most crops will experience a yield loss. In many crop scenarios, to maximize crop yield it is important that the water content at a particular field site be maintained somewhere between at the upper boundary, the field capacity of the field, and at the lower boundary, the permanent wilting point.

Agricultural producers are moving more and more toward the deployment of computers and software tools in the planning and execution of their cropping. Computer software tools and use of computers and analytics provide for a large number of additional options and for metrics and mathematics of a higher level of complexity than those which might have been used when manual planning tools, forms and other documents would have been used. The widespread acceptance of software tools in the agriculture industry provides an opportunity in many areas, including the area of crop planting and economics. A computerized method of estimating yield potential using plant-available water to forecast the yield potential for a crop would be desirable from a commercial perspective.

Continued evolution in field level agricultural cropping practices and enhancements is the desired outcome of the present invention—by making available methodology and tools which allow for microlevel planning farmers become more and more efficient and more and more profitable, with the added benefit of producing higher qualities and volumes of crops with given field areas and input availabilities etc. Achieving these objectives in a method that also allowed for enhanced environmental stewardship, by optimized use of water, fertilizer and other crop inputs would be favorably received.

The need to optimize water use while maximizing crop yields is also a pressing concern in irrigation applications. Efficient water management is essential for conserving water and ensuring the sustainability of agricultural practices. Traditional irrigation methods often lack precision, leading to inefficient water use. These methods typically involve fixed schedules or manual adjustments, which do not account for the dynamic nature of soil moisture levels, weather conditions, or the specific water needs of different crops. Consequently, such methods can result in over-irrigation, which wastes water and can lead to nutrient leaching and soil degradation, or under-irrigation, which can stress plants and reduce yields. To address these challenges, there is a significant need for advanced irrigation systems that can optimize water use by responding to real-time data on soil moisture and plant water requirements. If it were possible to control irrigation based on plant-available water metrics, it would represent a major advancement in agricultural technology. Such a system would allow farmers to apply the right amount of water at the right time, based on accurate, real-time soil moisture measurements and predictive crop water needs models.

By applying water only when and where it is needed, the system would significantly reduce water waste, preserving valuable water resources for other uses and future needs. Precise water management ensures that crops receive adequate hydration throughout their growth cycle, promoting healthier plants and potentially increasing yields. This is particularly important for high-value crops where yield and quality directly impact profitability.

Efficient water use also translates to lower water costs and reduced energy expenses associated with pumping and distributing water. This can lead to substantial cost savings for farmers and agricultural enterprises. A system that integrates real-time data and predictive analytics can adapt to varying weather conditions and changing crop requirements. This flexibility is crucial in managing the impacts of climate change and ensuring resilience in agricultural practices.

Overall, the development of an irrigation control system that leverages plant-available water metrics represents a significant technological advancement. It meets the dual objectives of conserving water and maximizing crop yields, addressing both economic and environmental imperatives in modern agriculture.

### SUMMARY OF THE INVENTION

The present invention relates to an irrigation control method using estimated moisture-based yield potential (YP) of an agricultural crop within a current growing season for a selected crop growing at a field site to predictably adjust irrigation schedules or actuate the application of additional irrigation water at the field site to optimize the crop yield. The method uses plant-available water calculations to provide its results.

The computerized method of the present invention uses a computer comprising a number of key systems and components. In addition to a control software component capable of facilitating the irrigation control method, the computer comprises a connection to a plurality of operative moisture data connections including a historical precipitation data source which contains daily average precipitation amounts for at least one historical growing season at the field site in question. The historical precipitation data source might be locally hosted on the computer, or could be a remote data source accessible locally or remotely via a computer network and the appropriate communications infrastructure and software. The historical precipitation data might be environmental rain data which was captured from a rain sensor at or near the field site. In other cases, the historical precipitation data source might be a weather dataset which relied upon sensors and other methods to provide geographically proximate calendar-based precipitation data to the field site—for example in certain cases there are networks of precipitation sensors used by weather reporting agencies that allow for extrapolation of reasonably geographically precise historical precipitation data, and it is also contemplated that this type of the data source could be used as the historical precipitation data source.

The operative moisture data connections also include a connection to an externally maintained current precipitation data source which contains daily actual precipitation amounts for the field site in question for each calendar day of the current growing season. Current precipitation information for the field site or sites in question. The current precipitation data source might be locally hosted on the computer, or could be a remote data source accessible locally or remotely via a computer network and the appropriate communications infrastructure and software. The historical precipitation data might be environmental rain data which was captured from a rain sensor at or near the field site. In other cases, the historical precipitation data source might be a weather dataset which relied upon sensors and other methods to provide geographically proximate calendar-based precipitation data to the field site—for example in certain cases there are networks of precipitation sensors used by weather reporting agencies that allow for extrapolation of reasonably geographically precise historical precipitation data, and it is also contemplated that this type of the data source could be used as the historical precipitation data source.

The moisture data connections also include a ground moisture data source, which is a data source storing periodically captured moisture sample values at the rooting depth of the selected crop at the growing site within the current season.

Another key element of the computer of the method of the present invention is an irrigation control interface, operatively connecting the computer to at least one irrigation controller capable of controlling irrigation at the field site. The irrigation controllers might be scheduled irrigation controllers which are programmed, static or dynamic schedule to actuate the application of water to the crop at the field site within the season, and the irrigation control interface might be capable of facilitating the transmission of a control signal to the irrigation controllers to modify the irrigation schedule, or in other cases the irrigation controllers might simply be actuated to apply more water to the field site instantaneously, if required. Both such approaches are contemplated within the scope of the present invention.

The method of the present invention is an irrigation control method that would operate on the system outlined within the current growing season to dynamically adjust the irrigation schedules applicable to irrigation controllers capable of applying water at a field site in accordance with the remainder of the method to optimize crop yield based upon a predetermined desired crop yield value and calculated crop yield potential within the growing season based upon moisture metrics.

In execution of the method, the system will need to establish certain values related to the current growing season, either by user data input, calculation or otherwise. The length and the specific calendar dates of the growing season for the selected crop at the field site are required. The planting date and the completion date will define the current season date range, as well as defining the corresponding calendar-based precipitation sampling used in a historical dataset to compare current year or current season precipitation information to historical precipitation information. The current growing season might be within a calendar year or might span adjacent calendar years—in either case, the historical data which is used to prepare the necessary comparative historical precipitation information would rely upon a similar chronological date range across earlier growth years.

The desired crop yield for the crop at the field site in the current growing season also needs to be established and stored for use by the system and the remainder of the method. This will effectively be the target value towards which the system will adapt the irrigation of the field site to achieve.

Each selected crop type will have a base amount of available water which is required to establish initial crop growth, which is referred to as the initial moisture factor (MF) for the selected crop. Initial moisture factors for various selected crop types can be maintained in a table in a data source or otherwise captured or indicated for use in accordance with the remainder of the forecasting method of the present invention.

Another method parameter which is required to be determined for the practice of the method of the present invention is the historical yield (Y_{Hist}) for the selected crop. The historical yield (Y_{Hist}) for the selected crop relates to the historical yield of the selected crop grown either at a typical field site by or selected by the producer. Additionally it is necessary to capture or determine a permanent wilting point (WP) of the field site, which relates to the inferior limit of crop available water in any given soil. At the wilting point the soil is dry, and plants can no longer extract any more water. The wilting point of a given soil is variable related to the soil texture, soil structure and organic matter content.

The method parameters to be determined also include the historical seasonal precipitation (P_{Hist}), being the total of daily average precipitation amounts for a calendar date range defined by the planting date to the completion date of the current growing season, based on data stored within a historical precipitation data source containing daily average precipitation amounts for the field site for each calendar day of at least one previous growing season. Historical precipitation data for more than one historical growing season could also be used once averaged or otherwise normalized, and both such approaches are contemplated within the scope of the present invention. The historical precipitation data source could be a database or data structure, where the method is being executed by computer software, or if a manual calculation or execution of the method were being used, a printed or static form dataset could also be used.

The method of the present invention which will be executed by the control software component and the remainder of the computer hardware components will execute a periodic monitoring loop within the growing season. The periodic monitoring loop could either be executed based upon a particular time frequency, or more likely based upon the detection of the capture of a new moisture sample value in the ground moisture data source.

Upon detection of a new moisture sample value in the ground moisture data source, the computer would calculate a raw soil water value (W_{Raw}) within the rooting depth, being the amount of plant-available water within the rooting depth at the sample date. One or more sample depths within the rooting depth could be used to determine the raw soil water value (W_{Raw}) within a rooting depth of the field site. One or more inground sensors can be used—for example, a single inground sensor may be capable of capturing moisture readings at more than one sample depth, or in other cases where inground sensors were used, multiple sensors could be used to capture the necessary moisture readings at the multiple sample depths. Alternatively, other embodiments of the method could use aboveground sensor technology, or manual soil test results, to establish the moisture readings at least one sample depth in the rooting depth of the field site.

A moisture based yield potential value (YP) for the crop at the field site in the current growing season would then be calculated by first determining a crop water use efficiency factor (F_{UE}) can be calculated using the formula:

$${F}_{UE} = \frac{{Y}_{Hist}}{{P}_{Hist} - MF}$$

The crop water use efficiency factor (F_{UE}) is a numerical multiplier representing the historical yield of the crop in question, per unit of in-season historical available water.

The system would next determine the forecast precipitation (P_{F}) at the field site from the calculation date to the completion date, which could either be done using historical precipitation from the historical precipitation data source for the remaining date range from the calculation date to the completion date, or could be determined based on other calculations or forecast information. The specifics of different methods for determining the forecast precipitation are outlined in further detail elsewhere herein.

The total available moisture (M_{Total}), representing the total amount of crop available water for the current growing season which will be available to the crop at the field site would next be calculated, using the formula:

$${M}_{Total} = ( ( {W}_{Raw} - WP ) + {P}_{R} + {P}_{F} ) - MF$$

Finally, the estimated yield potential (YP) for the crop would be calculated using the formula:

$$YP = {M}_{Total} * {F}_{UE}$$

The control software component would then determine if the calculated yield potential (YP) is lower than the established desired crop yield, and if so send a control signal to the at least one irrigation controller corresponding to the field site to adjust the application of water at the field site to modify the raw soil water value (W_{Raw}) within the rooting depth. The actuation of the irrigation controller(s) to apply additional or reduced water at the field site by the software will aid in decreasing or eliminating the difference between the calculated yield potential (YP) and the established desired crop yield. The periodic monitoring loop could then be executed again upon the next capture of moisture sample values from the ground moisture data source, and the ongoing calibration of the irrigation controller settings by communication and cooperation with the system of the present invention can continue.

A further embodiment of the present invention is the actual control software component itself-namely a non-transitory computer-readable storage medium storing processor instructions for use in the operation of a computer in a method of estimating yield potential within a current growing season for a selected crop planted at a field site, the computer-readable storage medium including instructions that when executed by a computer cause the computer to execute any of the embodiments of the method outlined herein and above. In many embodiments of the software of the present invention, the calculated yield potential would be stored in the memory of the computer.

At the core of the system of the present invention is the ability to provide schedule altering or actuation data to external irrigation controllers from the computer of the system of the present invention. Schedule based or instant activation irrigation controllers would typically be third-party hardware, capable of accepting schedule modification instructions or actuation instructions by a external command bus and it is contemplated that the system of the present invention will achieve its desired goal of optimized irrigation by integrating to issue and provide such external command bus instructions to those irrigation controllers.

Various data capture methods are understood for the periodically captured moisture sample values at the field site. They could be captured using manually extracted soil samples, or using at least one inground moisture sensor. All such approaches are contemplated within the scope of the present invention.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labelled with like numerals, and where:

FIG. 1 is a graph demonstrating the concept of plant-available water in a growing location, as outlined in further detail herein;

FIG. 2 is a flowchart demonstrating the steps in one embodiment of the forecasting method of the present invention;

FIG. 3A is a graphic extracted from an information management system in accordance with the present invention demonstrating captured sensor readings and the calculation of the raw soil water value (W_{Raw}) within a rooting depth of the field site at the planting date, in a field site, in accordance with the present invention;

FIG. 3B is a chart demonstrating a sample of numerical values in the calculation of crop yield potential (YP) in accordance with one embodiment at a particular date in accordance with the present invention;

FIG. 3C is a chart demonstrating numerical values and the calculation of crop yield potential (YP) at a later date in the growing season in accordance with the earlier data captured and outlined in FIGS. 3A and 3B;

FIG. 4 is a flowchart showing an alternate embodiment of the method of FIG. 2 in which a subjective agronomic factor (F_{Ag}) is applied to the yield potential forecast calculation;

FIG. 5 is a block diagram of one embodiment of a system architecture in accordance with the present invention; and

FIG. 6 is a flowchart demonstrating steps in one embodiment of the computer-driven irrigation control method of the present invention.

### DETAILED DESCRIPTION OF ILLUSTRATED EMBODIMENTS

The amount of water available to crops, as well as the timing of its availability, are believed to be two key metrics which can be used to accurately forecast on a real-time basis the likely yield potential for a selected crop at a field site in a growing season. Use of plant-available water statistics, rather than simple precipitation figures, provides a higher additional degree of granularity and accuracy in the forecasting which can be undertaken and can provide a forecast yield potential which more accurately estimates the potential yield of a crop even in circumstances of high precipitation figures resulting in excess amounts of moisture over the field capacity, or in drought scenarios where the amount of precipitation, taking into account field conditions, crop conditions and the like are insufficient to get above the permanent wilting point of the particular crop and field conditions.

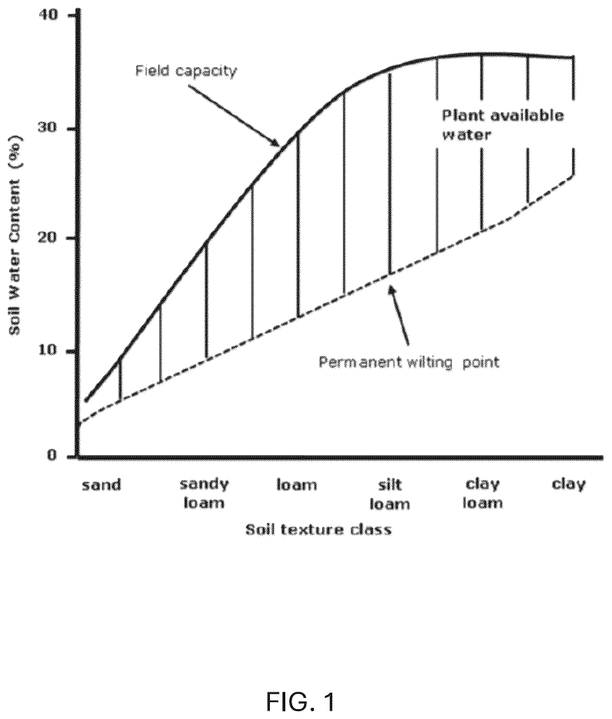

The use of plant-available water as an agronomic metric or tool will be understood to those skilled in the art, along with factors affecting its calculation, and it will be understood that the broadest concept of the present invention is intended to encompass any crop yield potential forecasting method based upon plant-available water calculations within a current or historical growing season. There are several factors in the determination of plant-available water, key amongst which is the soil type. Lighter styles of soil allow for the retention of less volume of water than for example clay or other more dense soil types which will inhibit the passage of water therethrough and allow for the longer-term availability of moisture within the soil. FIG. 1 demonstrates the correlation between plant-available water, between the field capacity and wilting point, and soil type of the field.

The present invention comprises a method of estimating yield potential (YP) within a current growing season for a selected crop growing in a field site embodied in a computer software forecasting tool and using the estimated yield potential in a corresponding irrigation control method. The yield potential (YP) forecast of the present invention is “water-driven” insofar as it relies upon real-time calculations of plant-available water to forecast the likely yield outcome of a particular selected crop at a field site in a current growing season.

Where used elsewhere in this specification and to outline the intended scope of the present invention, the following terms are defined as follows:
a) “calculation date” means the calendar date at which the sampling or relevant forecasting calculation will be conducted, being a calendar date between the planting date and the completion date;
b) “growing season” means the length of days defined by planting date and completion date, which define the current growing season. In certain cases and with certain selective crops more than one crop could be grown in a calendar year, or a growing season could extend between adjacent calendar years [with the attendant and understood modifications to the remainder of the method]. Relating the growing season of the selected crop to the calendar year is necessary since it is specifically contemplated that the historically available moisture figures contained within the historical precipitation data source would be captured or linked to calendar days, whereby for example if the growing season was defined as May 1 to September 15 for the selected crop in the current year, the historical data source could be assessed on the basis of precipitation in one or more previous calendar years in the same May 1 to September 15 window;
c) “historical seasonal precipitation (P_{Hist})” means the amount of precipitation at the field site selected for a selected crop between the same planting date and completion date in a prior calendar year, based on data stored within a historical precipitation data source containing daily average precipitation amounts for the field site for each calendar day of at least one previous growing season;
d) “historical yield (Y_{Hist})” means the historical yield of the selected crop at a typical field site of the producer or selected by the producer, which is used to calculate the historical water-driven crop production of the selected crop for translation into the current growing season;
e) “initial moisture factor (MF)” means the required amount of available water for a particular selected crop to establish initial crop growth;
f) “permanent wilting point (WP)” corresponds to the inferior limit of crop available water in a given soil. At the permanent wilting point, the soil is dry, and plants can no longer extract any more water. The permanent wilting point of a given soil is primarily related to soil texture. It may also be impacted by soil structure, organic matter content, or other factors;
g) “planting date” means the calendar date of planting of the selected crop at the field site;
h) “precipitation received (P_{R})” means the actual amount of precipitation received at the field site for a select crop for the current growing season, from the planting date to the calculation date;
i) “forecast precipitation (P_{F})” means the estimated amount of precipitation anticipated to be received at the field site for a selected crop for the remainder of the current growing season, from the calculation date to the season and date-either calculated based upon the same calendar date range from the historical precipitation data source, or based upon current season precipitation forecast information;
j) “raw soil water value (W_{Raw})” means the amount of plant-available water within the rooting depth of the field site at a particular date-effectively it comprises the moisture within the field site that is between, at the bottom of the range, the permanent willing point, and at the top of the range the maximum holding capacity of the field;
k) “rooting depth” means the depth of the field site within which the selected crop will grow;
l) “sample depth” means a particular depth level within the rooting depth of the field site, at which current moisture levels are measured for the purpose of ascertaining the raw soil water value within the rooting depth of the field;
m) “completion date” means the estimated calendar date of the completion of the growing season of the selected crop at the field site in the current growing season. The completion date of the growing season could be estimated based upon understood times for growing of the selected crop from planting to harvest. The end date of the growing season could be adjusted during the growing season, if required;
n) “selected crop” means any field crop which could be monitored and facilitated in accordance with the method of the present invention. Grains, pulses, vegetables, grasses and any other type of field crop are contemplated to be within the anticipated scope;
o) “subjective agronomic factor (F_{Ag})” means a multiplier or mathematical function which can be applied to a yield potential calculation which allows for the subjective influence of the yield potential forecasts of the present invention by additional agronomic variables;
p) “total available moisture (M_{Total})” means the sum of the raw soil water value less the wilting point of the field site, the precipitation received and the forecast precipitation at a field site, less the initial moisture factor; and
q) “yield potential (YP)” means the quantitative yield forecast for a selected crop at a field site, most often expressed in a production quantity of cropper unit of area of the field site (i.e. bushels per acres, tonnes per hectare, etc.)

### Crop Water Use Efficiency Factor:

The crop water use efficiency factor (F_{UE}) itself is a calculated value which based upon identified historical precipitation information and the other planting and cropping characteristics outlined can be applied to current seasonal precipitation information to yield an estimated yield potential for the crop at the conclusion of the current growing season in respect of which the forecast is conducted. The crop water use efficiency factor (F_{UE}) is calculated using the formula:

$${F}_{UE} = \frac{{Y}_{Hist}}{{P}_{Hist} - MF}$$

Where:
Y_{Hist} is the historical yield of the selected crop;
P_{Hist} is the historical seasonal precipitation being the total of daily average precipitation amounts for a calendar date range defined by the planting date to the completion date of the current growing season, based on data stored within a historical precipitation data source containing daily average precipitation amounts for the field site for each calendar day of at least one previous growing season; and
MF is the initial moisture factor for the selected crop.

The crop water use efficiency factor (F_{UE}) represents a quantity of crop production per unit of net precipitation based on a historical season scenario, which can be applied to a current season's precipitation results to ascertain the likely yield outcome in the current growing season.

The current season yield potential (YP) for the crop in the method of the present invention is calculated by multiplying the current season's anticipated total available moisture (M_{Total}) by the crop water use efficiency factor (F_{UE}). Creation of the crop water use efficiency factor (F_{UE}) based upon the mathematical approach and the plant-available water characteristics outlined herein, for use as an element in various agronomic or crop forecasting analysis functions, is explicitly intended to be covered within the scope of the present invention.

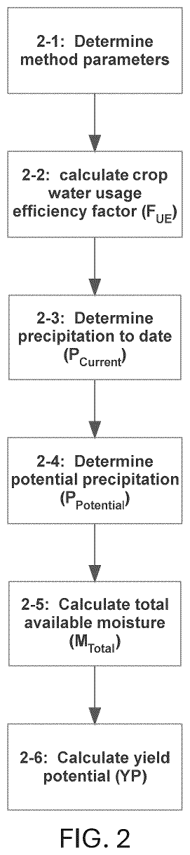

FIG. 2 demonstrates the steps in one approach to water-driven crop yield forecasting in accordance with the present invention—it is desired to show the calculations and their background so that their utility in the irrigation control method of the present invention can be understood . . . . The first step of the method is to determine a plurality of method parameters for use in the execution of calculations in accordance with the remainder of the method. This is shown at 2-1. The method parameters required in these most basic embodiments of the method are the planting date and the completion date for the selected crop at the field site in the current year, defining the current season date range. A calculation date within the current growing season between the planting date and the completion date would also be determined.

The historical seasonal precipitation (P_{Hist}), being the total of daily average precipitation amounts for a calendar date range defined by the planting date to the completion date of the current growing season, based on data stored within a historical precipitation data source containing daily average precipitation amounts for the field site for each calendar day of at least one previous growing season, would be calculated from data stored within a historical precipitation data source. It is also necessary to capture or determine an initial moisture factor (MF) for the selected crop, a historical yield (Y_{Hist}) for the selected crop, a permanent wilting point (WP) of the field site, and the raw soil water value (W_{Raw}) within a rooting depth of the field site at the planting date based on at least one moisture reading captured in relation to a sample depth within the rooting depth.

The next step in the method of the present invention, shown at 2-2, is the calculation of the crop water use efficiency factor (F_{UE}). The crop water use efficiency factor (F_{UE}) is calculated using the formula:

$${F}_{UE} = \frac{{Y}_{Hist}}{{P}_{Hist} - MF}$$

Following the determination or establishment of the crop water use efficiency factor (F_{UE}), the precipitation received (P_{R}) at the field site to date in the current growing season will be determined, from the planting date to the calculation date based upon data stored within a current precipitation data source. This is shown at step 2-3. In addition, forecast precipitation (P_{F}) at the field site for the remainder of the current growing season will also be determined, from the calculation date to the completion date of the current growing season-shown at 2-4. This could either be estimated using historical average precipitation data from the historical precipitation data source, or in other embodiments as outlined elsewhere herein current season weather forecast information could also be used in both such approaches are contemplated within the scope of the present invention. It is explicitly contemplated that the historical average data stored within the historical precipitation data source will provide good information for the calculation of forecast precipitation (P_{F}) but those skilled in the art of extrapolation of weather forecast and precipitation forecast information from current season forecast data will understand that there are credible approaches to using forecast information to extrapolate the forecast precipitation (P_{F}).

The next step, shown at 2-5, is the calculation of the total available moisture (M_{Total}) using the formula:

$${M}_{Total} = ( ( {W}_{Raw} - WP ) + {P}_{R} + {P}_{F} ) - MF$$

Finally, shown at 2-6, the crop water use efficiency factor (F_{UE}) would be applied to the total available moisture (M_{Total}) to yield the forecast yield potential (YP) for the selected crop for the current growing season using formula:

$$YP = {M}_{Total} * {F}_{UE}$$

The yield potential (YP) yielded by this calculation provides a forecast yield potential for the selected crop at the field site based upon the deviation of the precipitation between the planting date and the calculation date over the historical precipitation scenario encapsulated within the crop water use efficiency factor (F_{UE}).

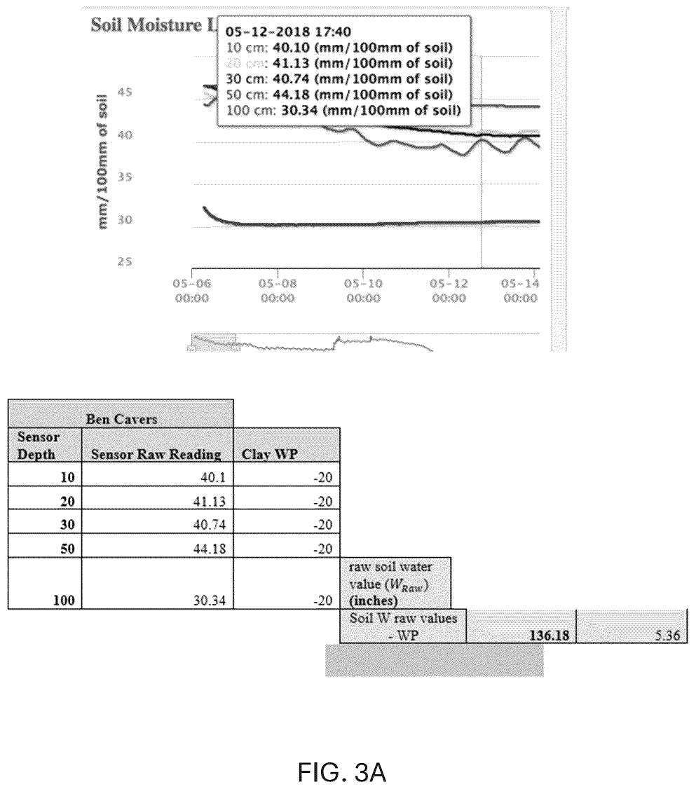

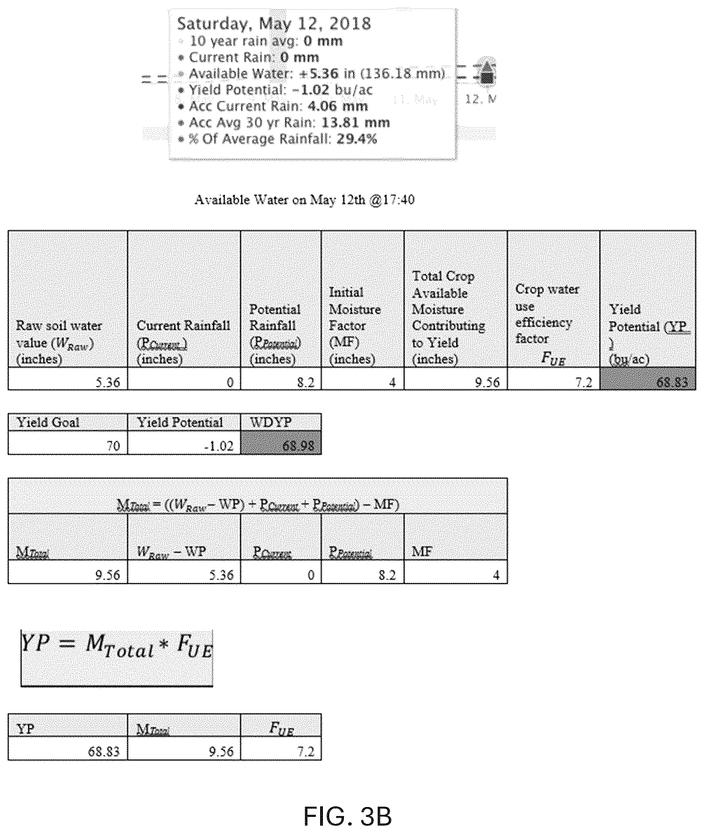

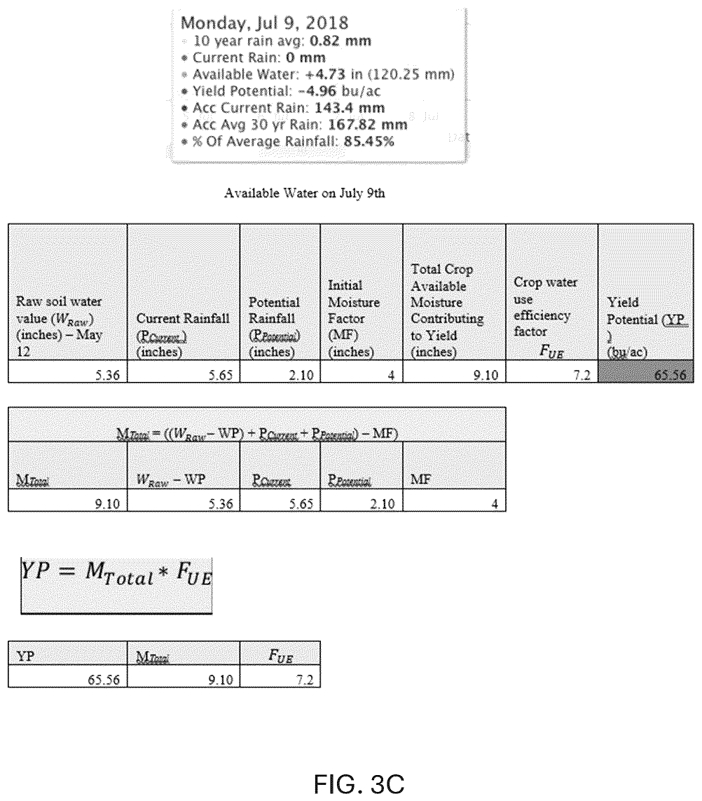

FIGS. 3A through 3C include the necessary data to demonstrate one sample calculation in accordance with the method of the present invention, being a water driven yield potential calculation based upon plant available water. Referring first to FIG. 3A, the data for the calculation of the raw soil water value (W_{Raw}) within a rooting depth of the field site at the planting date based on at least one moisture reading captured in relation to a sample depth within the rooting depth is shown. The date shown on this Figure, May 12, 2018, is the planting date for a selected crop at a field site, in respect of the examples provided. In the case of the sample calculations shown, five sensor depths are used to measure the soil moisture contents for calculation of the raw soil water value (W_{Raw})—measurements are taken as shown at 10, 20, 30, 50 and 100 cm. The five moisture sensor readings are combined to yield a raw soil water value (W_{Raw}) measurement of 5.36 inches. Where more than one moisture sensor reading is used in the generation of the raw soil water value (W_{Raw}) measurement, the moisture sensor readings could be weighted, averaged or otherwise transformed using a customized formula—where multiple moisture sensor readings are used, any means our method of converting those multiple readings into a usable raw soil water value (W_{Raw}) measurement for use in the remainder of the method of the present invention is contemplated within the scope hereof.

The measurement expressed in this Figure is in inches—it will be understood that the measurements used in the entire method of the present invention could be conducted in imperial or metric scales with appropriate conversions being applied. The raw soil water value (W_{Raw}) is effectively the moment-in-time water contents of the field site at the time the moisture measurements are taken, and for the purposes of the present invention and method would be captured at or near the planting date of the crop. Calculation of the raw soil water value (W_{Raw}) measurement would take place chronologically within the method of the present invention as described and outlined elsewhere herein. The raw soil water value calculated as of the planting date is used for calculations throughout the current growing season and the remainder of the method.

FIGS. 3B and 3C show the calculation of the yield potential (YP) for a selected crop at a field site at two different dates within a current growing season. Referring first to FIG. 3B the calculation of available water and yield potential at the date of May 12 is shown. As outlined above for the perspective of this Figure, May 12 is the planting date for the current growing season, so in addition to calculating the starting raw water values, in this particular calculation, the planting date and the calculation date are the same. As can be seen in the calculations outlined and enabled in this Figure, based upon the raw soil water value, a current rainfall value of zero given that the calculation date is the planting date, and an estimated potential rainfall for the remainder of the current growing season of 8.2 inches, the forecast yield potential for the crop in the current growing season is 68.83 bushels per acre. Moving forward in time to July 9, as shown in FIG. 3C, there is now current rainfall information available from May 12 to July 9, at a value of 5.65 inches, with the forecast potential rainfall for the remainder of the growing season at 2.1 inches. As can be seen, this represents a modest decrease, based on actual precipitation figures, and the estimated seasonal available water over the scenario first calculated at the commencement of the growing season, resulting in a modified and reduced yield potential calculation of 65.56 bushels per acre.

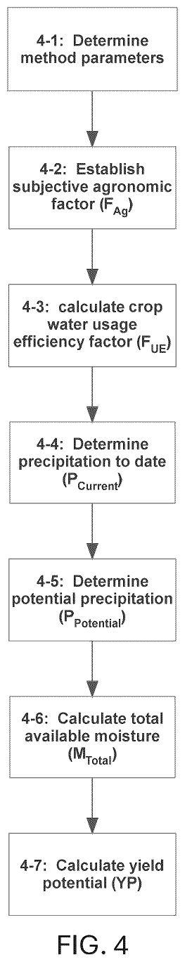

FIG. 4 demonstrates an alternate embodiment of the calculation of the present invention, incorporating the use of a subjective agronomic factor (F_{Ag}) to adjust for any additional agronomic variables which would alter crop water usage in the current growing season. These could be everything from the incorporation of additional individual measurable parameters at the crop site through to even something as simple as a “black box” multiplier or mathematical factor which certain agronomists might like to apply to fine tune or refine yield potential outputs. In embodiments such as that of FIG. 4 incorporating a subjective agronomic factor (F_{Ag}), the formula for calculation of the yield potential (YP) is calculated using the modified formula:

$$YP = {M}_{Total} * {F}_{UE} * {F}_{Ag}$$

The subjective agronomic factor (F_{Ag}) as a multiplier used in the formula for determination of yield potential, which might have a default value of 1, could be adjusted based on additional agronomic variables to either increase the forecast yield potential, by increasing the value of the subjective agronomic factor (F_{Ag}) above 1, or to decrease the forecast yield potential by decreasing the value of the subjective agronomic factor (F_{Ag}) below 1. Establishment of the subjective agronomic factor (F_{Ag}) is shown at 4-2 following the determination of the method parameters which might include the indicators of the additional agronomic variables required to establish the subjective agronomic factor (F_{Ag}), at 4-1. In other embodiments, rather than capturing the additional agronomic variables in the method parameters, capture of the method parameters might include the capture or determination directly of the subjective agronomic factor (F_{Ag})—such as for example where the agronomist advising the agricultural producer might wish to spply a specified “black box” variable or multiplier to the formula in question. All such approaches are contemplated within the scope of the present invention. The remainder of the steps of FIG. 4 is the same as that of FIG. 2, with the exception of the establishment of the subjective agronomic factor (F_{Ag}), and that the yield potential calculation in 4-7 would use the modified formula outlined above.

### Desired Crop Yield:

The system and method of the present invention as claimed rely upon an established desired crop yield variable which would be established by the operator either before the commencement of the growing season or even entered or adjusted during the growing season to modify the behavior of the method. The desired crop yield could be determined by the operator based upon past crop of formants at the field site or adjunct of the present software crop potential and allow for user adjustment via an interface. The desired crop yield, regardless of the nature of its data entry or determination, will be understood to those skilled in art and understood to be within the scope of the present invention.

### Illustrative Environment and System Architecture:

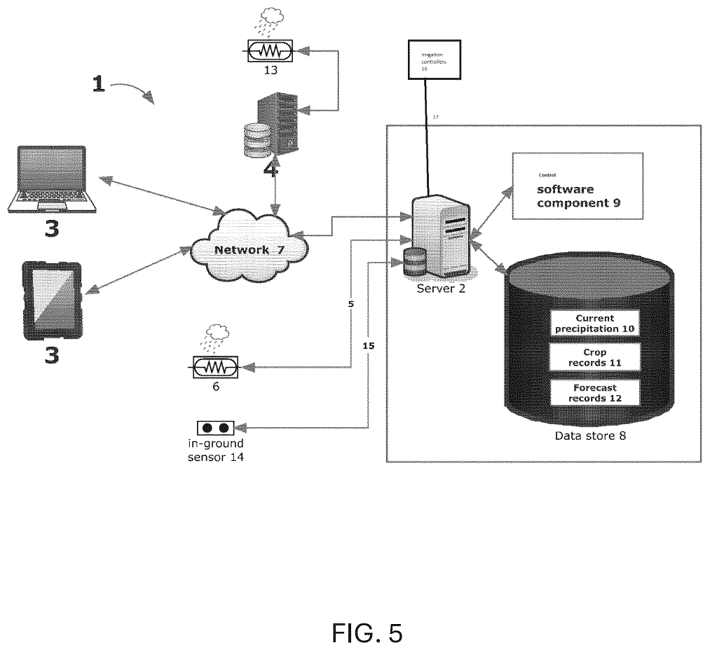

FIG. 5 shows an illustrative architecture of an overall computer system 1 in accordance with the present invention. The particular architecture shown in this Figure is a client/server system, the server being the computer 2 which will host the data and software to administer the method, and client devices 3 capable of communicating with the computer 2 for the purpose of user interaction. As outlined elsewhere herein and below, it is explicitly contemplated that this type of a system in accordance with the method of the present invention could be a website system, although a proprietary communication and software system could also be used in both such approaches will be understood to be within the scope of the present invention.

The computer 2 is a computer capable of communication with other components via a network interface, as well as posting or being accessible to a control software component 9 which is the software which will administer the method of the present invention as well the data store 8 that contains in the Figure is shown a plurality of datasets relevant for these purposes. The data store 8 as shown demonstrates the current precipitation data source 10 and a plurality of crop records 11. The computer 2 is shown connected to an external network 7 by which additional devices may communicate therewith. For example, two client devices 3 which would potentially be the interfaces by which users would participate in the execution of the method of the present invention are shown.

The historical precipitation data source computer 4 is shown in turn connected to a precipitation sensor 13. The sensor 13 might be a site proximate precipitation sensor, or else the historical precipitation data set contained within the computer 4 may aggregate weather information from other networks etc. It will be understood that any type of a dataset which contains historical precipitation data of sufficient particularity, granularity in proximity to the field sites in question will be within the intended scope of this element of the invention.

Also shown connected to the computer 2 is a current precipitation sensor 6 connected via a network communications bus 5. The current precipitation sensor 6 could capture precipitation data at or near the growing site for the crop being monitored, for logging of such information into the current precipitation dataset 10 for use in accordance with the remainder of the present invention. Again as is outlined elsewhere herein with respect to this aspect of the method as well as the historical precipitation data source, the current precipitation dataset 10 might be populated by data captured by a local precipitation sensor or data source 6, or via replacing the current precipitation data sensor 6 with access for example to a third-party weather service or some other means of obtaining locally relevant and site proximate precipitation data.

Also shown in this particular Figure is an in-ground sensor 14 which could be used to capture the current precipitation readings within the field site at any particular chosen time, within the rooting depth. The sensor 14 is shown in communication with the computer 2 via a communications bus shown at 15.

Multiple types of in-ground moisture sensors could be used to facilitate the method of the present invention. As outlined throughout this application, it is explicitly contemplated that inground moisture sensors capable of reading from a single depth within the rooting depth of a field site, or other inground moisture sensors which will permit the acquisition of multiple steps readings within the rooting depth of the field site are both contemplated within the scope of the present invention. In embodiments of the method of the present invention in which it is desired to increase the accuracy and granularity of the method by using readings from multiple depths within the rooting depth of the field site, either a single multi-depth sensor or multiple single depth sensors could be used. Both such approaches are contemplated within the present invention.

Dependent upon the remainder of the architecture of the system being used to administer the method, the computer 2 might communicate directly with the inground sensor 14 via a wired or wireless connection, or in other cases the sensor 14 might provide remote information to the network interface of the computer 2 via an API or the like to a third-party provider. For example it is explicitly contemplated that the system and method of the present invention could be used by agronomist or a farmer to conduct yield potential forecasting with respect to their crops and use either current soil sample or soil moisture readings or even current precipitation readings from a third-party service who could be a service provided to the farmer for other purposes—for example other companies may provide to the farmer access to the necessary sensing technology for use in multiple applications on a farm and it is explicitly contemplated and will be obvious to those skilled in the art of network communications and system design that accessing remotely hosted or acquired inground moisture readings or the like from a remote data source for use by the computer 2 in the administration of the method of the present invention is contemplated within the scope hereof.

Also shown in this Figure is a irrigation control interface connection 17 to at least one irrigation controller 16 irrigation equipment for water delivery at the field site of a crop being managed pursuant to the system of the present invention. The computer 2 can send a signal via the irrigation control interface 17 to the at least one irrigation controller 16 field site if determined to be required, or more likely than not if the irrigation controller 16 is a scheduled controller the command that would be dispatched via the irrigation control interface would be a command that would be determined and interpreted as a schedule alteration command at the at least one irrigation controller 16 in question.

The embodiment shown in these Figures includes a crop database 11 within the data store 8. A crop database 11 including crop records for various crops and field sites being managed in accordance with the method of the present invention will be understood to those skilled in the art of software and control system design. The control software component 9 would comprise subroutines for the administration of the current precipitation data source 10 if locally hosted, and the crop database 11. Additionally, the software component would facilitate the execution of user interface transactions with user devices, as well as executing searches and reporting against the data store 8 as might be required. Finally and most importantly, the control software component 9 would also execute the mathematical operations for the calculation of the crop water use efficiency factor, the available total moisture and the water-driven yield potential in the forecasting method and determining and dispatching necessary control instructions to the irrigation controllers 16 by the irrigation control interface 17.

Also shown in this Figure is the network interface 22. The network interface 22 would comprise the necessary hardware and software components resident on or installed upon the computer 2 which would allow the computer 2 to communicate with user devices, remote data sources and any other networked components in the facilitation of the method. The network interface 22 could be any wired or wireless interface using a network protocol allowing the computer 2 to communicate with the necessary devices over a wide or local area.

### Control Software Component:

The details of the required computer processor instructions required in the control software component 9 to permit the conduct of the method as outlined herein will be understood to those skilled in the art of database design and computer software programming and any type of an approach that yields computer software executable upon computer capable of executing the steps of the method of the present invention is contemplated within the scope hereof. In addition to the method outlined herein it is explicitly contemplated that the invention as claimed also encompasses a non-transitory computer-readable storage medium for use in a method of irrigation control using estimated yield potential within a current growing season for a selected crop planted at a field site, the computer-readable storage medium including instructions that when executed by a computer cause the computer to execute any series of steps equating to the methods outlined above and described in reference to the claims and embodiments outlined herein. The remainder of the variations, parameters and embodiments of the method of the present invention outlined elsewhere herein could all be achieved using the non-transitory computer readable storage medium and software stored thereon.

### Types of Irrigation Controllers

There are at least two types of irrigation control methodologies which are contemplated to be usable with the system of the present invention:
a) Schedule-Based Controllers: For schedule-based controllers, the control signal sent from the system modifies the irrigation schedule to increase or decrease water application as needed; and
b) Real-Time Controllers: For real-time controllers, the control signal sent from the system instructs the controller to immediately commence increased or decreased water application.

It will be understood that the system and method of the present application could be modified to communicate and control any number of different types of irrigation controllers, requiring data packets or instructions to be received via their control bus or network connection in varying ways and all such approaches are contemplated within the scope of the present invention.

### Historical Precipitation Data Source:

The historical precipitation data source is any readable dataset which can be used by the computer 2 in association with the remainder of the method of the present invention to assess precipitation on a daily basis, for the purpose of calculating comparatively the aggregate amounts of precipitation which have been historically available to crops at the selected field site, for use in association with the remainder of the present invention. In the system embodiment shown in FIG. 5, the historical data source 4 is a remote network-connected computer and containing the necessary historical precipitation information. It is particularly contemplated that from a historical perspective the dataset and the data source used might be a publicly available weather dataset in which precipitation information may be contained. Farmers might also have their own historical datasets which they capture with relation to their specific field sites, and both such approaches are contemplated within the scope of the present invention. By using a historical precipitation data source that contains calendar correlated precipitation data, day by day plant-available water calculations that historical dates can be used if desired to do so. The historical precipitation data source would likely contain precipitation data from at least one precipitation sensor proximate to the field site. Precipitation data might be environmental rain data captured from a rain sensor, or other types of locally captured data or sensor readings which can be used to determine precipitation received. Any type of a sensor and a historical precipitation data source which contains the necessary information to on a date basis ascertain precipitation received at the field site, which can be combined with other method parameters to determine plant-available water in that particular historical date, will be useful and are contemplated within the context and extent or scope of the present invention.

The historical precipitation data source could contain data from more than one previous growing season and if that were the case, the data from multiple previous historical growing seasons at the field site could be averaged or otherwise formatted or transformed for use in accordance with the remainder of the present invention. The historical precipitation data source is explicitly contemplated in software embodied approaches to the invention a network data source readable by a computer. The historical precipitation data source could be a locally hosted dataset on a local computer executing software to run the forecasting scenarios of the present invention or could be a remote or even third-party provided dataset which was operably connected to a computer executing software to run the forecasting scenarios.

### Current Precipitation Data Source:

The current precipitation data source is any readable dataset which can be used by a computer in association with the remainder of the method of the present invention to assess precipitation and plant-available water on a daily basis, for the purpose of calculating comparatively the aggregate amounts of plant-available water which have been available to the selected crop at the field site within the current growing season. In the system embodiment shown in FIG. 5, the current precipitation data source 10 is a locally hosted dataset containing the necessary current season precipitation information, which would be captured via the interface 15 from the inground sensor 14. The current growing season precipitation data source 10 might also be a remote or third-party service if the remote or third-party service has access to sensor data of particular geographic relevance.

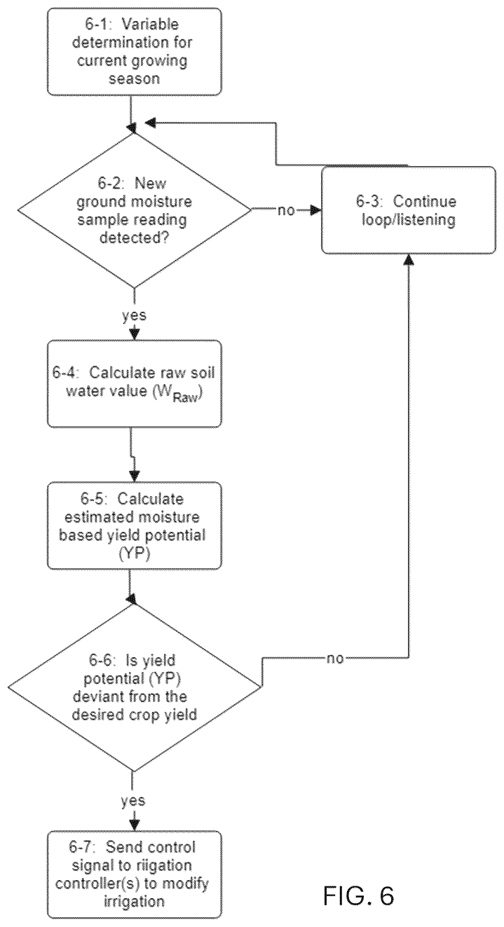

Using a calendar correlated current precipitation data source 10 provides day by day plant-available water capability which can be used to an aggregate calculate the plant-available water in the growing season to date. Based on locally captured precipitation information or remotely maintained locally captured information, any type of a sensor and current precipitation data source 10 which contains the necessary information to on a date basis calculate the precipitation received at the field site along with determining the plant-available water by applying the other method parameters thereto is contemplated within the scope of the present invention. The current precipitation data source 10 as shown in FIG. 6 is a locally hosted software dataset. Remotely hosted information accessible to the computer 2 via a network interface is also contemplated to be within the scope of the present invention.

### Crop Database:

The operability of the method and the computer-based embodiments of the invention, relying in part upon a crop database 11 will be understood to those skilled in the art and any approach accomplishing this objective will be understood to be within the scope of the present invention. The crop database 11 might be resident on the computer 2, or might alternatively be resident on or administered remotely within a network connected server from the database environment which is operatively connected for communication with the computer 2 the remainder of the system of the present invention. The crop database 11 might also comprise multiple databases or files rather than a single database file structure.

The system embodiment in FIG. 5 demonstrably illustrates the crop database 11 and the current precipitation data source 10 all being resident in a single locally administered data store 8. It will be understood that separate data structures for each of these datasets, or even some of them being locally hosted on the computer 2 is being accessible via a local or wide area network connection are all contemplated as approaches which could be within the scope intended.

### Method Overview:

A computerized embodiment of the present invention as shown and described in relation to FIG. 6 is a method of irrigation control using crop water efficiency metrics. The crop water use efficiency factor (F_{UE}) is a numerical multiplier representing the historical yield of the crop in question, per unit of in-season historical precipitation and available water, and can be used to forecast yield potential (YP) for a selected crop in a current growing season by multiplying the total available moisture for the current growing season with the crop water use efficiency factor.

FIG. 6 is a flowchart demonstrating the steps of a first embodiment of the irrigation control method of the present invention. The method as outlined throughout the specification relies upon the use of a computer which includes a control software component capable of facilitating the irrigation control method; operative moisture data connections to an externally-maintained historical precipitation data source containing daily average precipitation amounts for the field site for each calendar day of at least one previous growing season, an externally-maintained current precipitation data source containing daily average precipitation amounts for the field site for each calendar day of the current season, and a ground moisture data source being a data source storing periodically captured moisture sample values at the rooting depth of the growing site within the current season; and an irrigation control interface operably connected to at least one irrigation controller controlling irrigation at the field site.

The method comprises, by operation of the computer and the control software component, a first step in which variables/parameters related to the current growing season are established, as shown in 6-1. This includes the capture or determination of the following:
a) desired crop yield for the crop at the field site in the current growing season;
b) the length and the specific calendar dates of the growing season for the selected crop at the field site. The planting date and the completion date will define the current season date range, as well as defining the corresponding calendar-based precipitation sampling used in a historical dataset to compare current year or current season precipitation information to historical precipitation information;
c) each selected crop type will have a base amount of available water which is required to establish initial crop growth, which is referred to as the initial moisture factor (MF) for the selected crop. Initial moisture factors for various selected crop types can be maintained in a table in a data source or otherwise captured or indicated for use in accordance with the remainder of the forecasting method of the present invention;
d) historical yield (Y_{Hist}) for the selected crop, which relates to the historical yield of the selected crop grown either at a typical field site by or selected by the producer;
e) a permanent wilting point (WP) of the field site, which relates to the inferior limit of crop available water in any given soil. At the wilting point the soil is dry, and plants can no longer extract any more water. The wilting point of a given soil is variable related to the soil texture, soil structure and organic matter content; and
f) historical seasonal precipitation (P_{Hist}), being the total of daily average precipitation amounts for a calendar date range defined by the planting date to the completion date of the current growing season, based on data stored within a historical precipitation data source containing daily average precipitation amounts for the field site for each calendar day of at least one previous growing season.

The data capture step could be conducted at the time of commencement of the forecasting calculation in accordance with the method, or in other embodiments of this particular method or approach some or all of the method parameters to be captured and stored in the memory of the computer so that they could be recalled by the control software component for subsequent reuse and subsequent iterations of the forecasting transaction or calculation of the present invention. It will be understood that the capture of the parameters in this step can be done at the beginning of the growing season or adjusted during the season but is not required to be updated on the same frequency as the periodic monitoring loop.

The method of the present invention which will be executed by the control software component and the remainder of the computer hardware components will execute a periodic monitoring loop within the growing season. The periodic monitoring loop could either be executed based upon a particular time frequency, or more likely based upon the detection of the capture of a new moisture sample value in the ground moisture data source.

Shown next at step 6-2 is the opening of a periodic monitoring loop which would be executed by the control software component on the computer-typically upon detection of the capture of a new moisture sample value in the ground moisture data source, although it could also be done on a periodic time-based frequency etc. As shown in the Figure if a new moisture sample value were detected, a subroutine would be executed in which effectively the current raw soil water value would be determined along with other crop water efficiency metrics to determine if it was necessary based upon the current estimated yield potential of the crop to adjust the irrigation schedule or apply irrigation to the field. If no new moisture sample value is determined at the point in time that the listener is executed it can be seen that the loop will simply continue, at 6-3. It will be understood that there are many ways to approach the periodic frequency loop/monitoring approach discussed herein and all are contemplated within the scope of the present invention.

When a new moisture sample value is determined having been logged in the ground moisture data source, or upon whatever other frequency-based triggering methodology is employed, the software component 9 will calculate a raw soil water value (W_{Raw}) within the rooting depth, being the amount of plant-available water within the rooting depth at the sample date. This is shown at Step 6-4. The next step following this would be the calculation of a moisture based yield potential value (YP) for the crop in the growing season by:
a. calculating a crop water use efficiency factor (F_{UE}) using the formula:

$${F}_{UE} = \frac{{Y}_{Hist}}{{P}_{Hist} - MF}$$

determining the forecast precipitation value (P_{F}) at the field site from the calculation date to the completion date;
b. calculating the total available moisture (M_{Total}) using the formula:

$${M}_{Total} = ( ( {W}_{Raw} - WP ) + {P}_{R} + {P}_{F} ) - MF$$

and
i. calculating the yield potential (YP) using the formula:

$$YP = {M}_{Total} * {F}_{UE}$$

Having determined the calculated yield potential, the software component 9 will then compare the calculated yield potential to the desired crop yield (Step 6-6), and if the calculated yield potential (YP) differs from the established desired crop yield by more than a desired threshold amount, a control signal will be sent (Step 6-7) to the at least one irrigation controller corresponding to the field site to adjust the application of water at the field site to modify the raw soil water value (W_{Raw}) within the rooting depth, resulting in more or less water being applied by the irrigation systems in question to the crop at the field site. The actuation of the irrigation controller(s) to apply additional or reduced water at the field site will aid in decreasing or eliminating the difference between the calculated yield potential (YP) and the established desired crop yield.

The threshold amount value used to determine whether or not there is sufficient deviation to require irrigation adjustment could be established by the user in respect of an individual crop or could be a systemwide value. Either such approaches contemplated within the scope of the present invention.

In certain cases as discussed, the calculations used by the software component line to assess the desirability of the application of more or less water could factor in a subjective agronomic factor (F_{Ag})—the actual formula used for the rendering in this embodiment is as follows, reflecting the subjective agronomic factor:

$$YP = {M}_{Total} * {F}_{UE} * {F}_{Ag}$$

As outlined it is explicitly contemplated that the way that the subjective agronomic factor (F_{Ag}) might most easily be reflected in calculations in accordance with the remainder of the method of the present invention would be to stipulate that the subjective agronomic factor (F_{Ag}) was a multiplier applied to the formula, with a default value of 1. If it was desired to apply agronomic variables that resulted in the higher use of water, reflecting a potential lowering of the yield potential (YP), the multiplier could be lowered into the range between zero and one, and if it was desired to provide a yield potential boost in the calculation i.e. less water was required, the multiplier could be increased above one. It will however be understood that there will be other ways applying or determining a subjective agronomic factor (F_{Ag}) as well-a multiplier or other type of mathematical function could be used and any type of a mathematical modification which could be codified in the control software component for the purpose of applying multiple additional agronomic variables to the calculations rendered in accordance with the remainder of the method of the present invention will be understood to be contemplated within the scope hereof.

### Multi-Crop Control Method:

It is also specifically contemplated that the method of the present invention could be implemented in a way that would allow for the monitoring and irrigation control of multiple crop and field site combinations for multiple producers using a single physical system and control software component, with the necessary and appropriate, and understood in the art, security framework and design.

The system of the proposed invention will provide an elaborate irrigation control method which will incorporate not only precipitation values at the field location but actual specific water requirements of the crop to reach a desired yield outcome. This is a significant advancement over the current state of the art.

It will be apparent to those of skill in the art that by routine modification the present invention can be optimized for use in a wide range of conditions and application. It will also be obvious to those of skill in the art that there are various ways and designs with which to produce the apparatus and methods of the present invention. The illustrated embodiments are therefore not intended to limit the scope of the invention, but to provide examples of the apparatus and method to enable those of skill in the art to appreciate the inventive concept.

Those skilled in the art will recognize that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. An irrigation control method using estimated moisture-based yield potential (YP) for a selected crop growing at a pre-defined field site for a current growing season having a current season date range extending from the planting date to the completion date, the method using a computer comprising:
a. a control software component capable of facilitating the irrigation control method;
b. operative moisture data connections to:
i. an externally-maintained historical precipitation data source containing daily average precipitation amounts for the field site for each calendar day of at least one previous growing season;
ii. an externally-maintained current precipitation data source containing daily average precipitation amounts for the field site for each calendar day of the current season; and
iii. a ground moisture data source being a data source storing periodically captured moisture sample values at the rooting depth of the growing site within the current season; and
c. an irrigation control interface operably connected to at least one irrigation controller controlling irrigation at the field site;
the method comprising:
i) in respect of the current growing season:
a. establishing a desired crop yield for the crop at the field site;
b. using historical precipitation data values from the historical precipitation data source to identify daily average precipitation amounts for the field site for each calendar day of at least one prior growing season corresponding to the calendar dates of the current season date range, being historical daily average precipitation amounts;
c. calculating the historical seasonal precipitation value (P_{Hist}) for at least one prior growing season, being the total of historical daily average precipitation amounts corresponding to the calendar days within the current season date range;
d. determining an initial moisture factor value (MF) for the selected crop, being the required amount of available water for the selected crop to establish initial crop growth, a historical yield value (Y_{Hist}) for the selected crop, and a permanent wilting point value (WP) of the field site, being the minimum amount of crop available water in the soil of the field site that is required by the crop not to wilt;
ii) in a periodic monitoring loop, upon detection of the capture of a new moisture sample value in the ground moisture data source:
a. calculating a raw soil water value (W_{Raw}) within the rooting depth, being the amount of plant-available water within the rooting depth at the sample date;
b. calculating a moisture based yield potential value (YP) for the crop in the growing season by:
i. calculating a crop water use efficiency factor (F_{UE}) using the formula:
$${F}_{UE} = \frac{{Y}_{Hist}}{{P}_{Hist} - MF}$$
ii. determining the forecast precipitation value (P_{F}) at the field site from the calculation date to the completion date;
iii. calculating the total available moisture (M_{Total}) using the formula:
$${M}_{Total} = ( ( {W}_{Raw} - WP ) + {P}_{R} + {P}_{F} ) - MF$$
and
iv. calculating the yield potential (YP) using the formula:
$$YP = {M}_{Total} * {F}_{UE}$$
and
c. if the calculated yield potential (YP) differs from the established desired crop yield by more than an established threshold amount, sending a control signal to the at least one irrigation controller corresponding to the field site to adjust the application of water at the field site to modify the raw soil water value (W_{Raw}) within the rooting depth;
wherein the actuation of the irrigation controller(s) to apply additional or reduced water at the field site will aid in decreasing or eliminating the difference between the calculated yield potential (YP) and the established desired crop yield.

2. The method of claim 1, wherein the periodically captured moisture sample values for a sample depth are determined using manually extracted soil samples.

3. The method of claim 1, wherein the periodically captured moisture sample values for a sample depth are determined using at least one in-ground moisture sensor.

4. The method of claim 1, wherein the historical precipitation data source contains precipitation data from at least one precipitation sensor proximate to the field site.

5. The method of claim 1, wherein the historical precipitation data source contains precipitation data for more than one previous growing season and averages the multiple previous years precipitation readings for each date within the calendar year.

6. The method of claim 1, wherein the current precipitation data source comprises precipitation data from at least one precipitation sensor proximate to the field site.

7. The method of claim 1, wherein the forecast precipitation value (P_{F}) is calculated from the corresponding calendar date range from the calculation date to the completion date in the historical precipitation data source.

8. The method of claim 1, wherein the forecast precipitation value (P_{F}) is identified from future precipitation forecasts.

9. The method of claim 1, wherein the yield potential (YP) is determined incorporating non-moisture based agronomic variables by:
a. modifying the data capture step to further capturing a subjective agronomic factor (F_{Ag}) or the additional non-moisture based agronomic variables from which a subjective agronomic factor (F_{Ag}) can be determined; and
b. yield potential (YP) is determined by a modified formula:
$$YP = {M}_{Total} * {F}_{UE} * {F}_{Ag}$$
wherein F_{Ag} has a default value of 1, adjusted for any non-moisture-based agronomic variables which would alter crop water usage in the current growing season.

10. The method of claim 9, wherein the additional agronomic variables used to establish the subjective agronomic factor (F_{Ag}) are selected from the group of:
a. field stresses for the field site;
b. soil test values for the field site;
c. planned fertilizer application rates for the field site;
d. the planned timing for fertilizer application within the current growing season;
e. details of planned chemical applications at the field site; and
f. specific growing characteristics of the selected crop.

11. The method of claim 1, wherein the at least irrigation controller is a schedule-based controller, and the control signal sent from the system to the controller is a data instruction to modify the irrigation schedule for the field site to increase or decrease water application.

12. The method of claim 1, wherein the at least irrigation controller is a real-time controller, and the control signal sent from the system to the controller is a data instruction to immediately commence increased or decreased water application.

13. A method of estimating yield potential (YP) and controlling irrigation for a selected crop growing at a field site for a current growing season having a planting date and a completion date, the method comprising:
a. capturing at least one moisture reading in relation to a sample depth within a rooting depth of the field site at a sample date;
b. using the at least one moisture reading and other necessary method parameters to calculate the raw soil water value (W_{Raw}) within the rooting depth;
c. calculating the total available moisture (M_{Total}) using the raw soil water value (W_{Raw}), the precipitation received (P_{R}) at the field site to date, and the forecast precipitation (P_{F}) at the field site for the remainder of the current growing season;
d. calculating the yield potential (YP) for the crop in the growing season based on the total available moisture (M_{Total}); and
e. controlling an irrigation controller at the field site based on the calculated total available moisture (M_{Total}) to optimize the water application for achieving the desired crop yield.

14. The method of claim 13, further comprising the step of updating the irrigation control parameters in real-time based on updated moisture readings and precipitation forecasts.

15. A system for execution of an irrigation control method using estimated moisture-based yield potential (YP) for a selected crop growing at a pre-defined field site for a current growing season having a current season date range extending from the planting date to the completion date, the system comprising a computer having:
a. a control software component capable of facilitating the irrigation control method;
b. operative moisture data connections to:
i. an externally-maintained historical precipitation data source containing daily average precipitation amounts for the field site for each calendar day of at least one previous growing season;
ii. an externally-maintained current precipitation data source containing daily average precipitation amounts for the field site for each calendar day of the current season; and
iii. a ground moisture data source being a data source storing periodically captured moisture sample values at the rooting depth of the growing site within the current season; and
c. an irrigation control interface operably connected to at least one irrigation controller controlling irrigation at the field site;
the system capable of executing the irrigation control method comprising:
iii) in respect of the current growing season:
a. establishing a desired crop yield for the crop at the field site;
b. using historical precipitation data values from the historical precipitation data source to identify daily average precipitation amounts for the field site for each calendar day of at least one prior growing season corresponding to the calendar dates of the current season date range, being historical daily average precipitation amounts;
c. calculating the historical seasonal precipitation value (P_{Hist}) for at least one prior growing season, being the total of historical daily average precipitation amounts corresponding to the calendar days within the current season date range;
d. determining an initial moisture factor value (MF) for the selected crop, being the required amount of available water for the selected crop to establish initial crop growth, a historical yield value (Y_{Hist}) for the selected crop, and a permanent wilting point value (WP) of the field site, being the minimum amount of crop available water in the soil of the field site that is required by the crop not to wilt;
iv) in a periodic monitoring loop, upon detection of the capture of a new moisture sample value in the ground moisture data source:
a. calculating a raw soil water value (W_{Raw}) within the rooting depth, being the amount of plant-available water within the rooting depth at the sample date;
b. calculating a moisture based yield potential value (YP) for the crop in the growing season by:
i. calculating a crop water use efficiency factor (F_{UE}) using the formula:
$${F}_{UE} = \frac{{Y}_{Hist}}{{P}_{Hist} - MF}$$
ii. determining the forecast precipitation value (P_{F}) at the field site from the calculation date to the completion date;
iii. calculating the total available moisture (M_{Total}) using the formula:
$${M}_{Total} = ( ( {W}_{Raw} - WP ) + {P}_{R} + {P}_{F} ) - MF$$
and
iv. calculating the yield potential (YP) using the formula:
$$YP = {M}_{Total} * {F}_{UE}$$
and
c. if the calculated yield potential (YP) differs from the established desired crop yield by more than an established threshold amount, sending a control signal to the at least one irrigation controller corresponding to the field site to adjust the application of water at the field site to modify the raw soil water value (W_{Raw}) within the rooting depth;
wherein the actuation of the irrigation controller(s) to apply additional or reduced water at the field site will aid in decreasing or eliminating the difference between the calculated yield potential (YP) and the established desired crop yield.

16. The system of claim 15, wherein the at least irrigation controller is a schedule-based controller, and the control signal sent from the system to the controller is a data instruction to modify the irrigation schedule for the field site to increase or decrease water application.

17. The system of claim 15, wherein the at least irrigation controller is a real-time controller, and the control signal sent from the system to the controller is a data instruction to immediately commence increased or decreased water application.
